(19) United States
(12) Patent Application Publication
(10) Pub. No.: US 2004/0133625 A1
(43) Pub. Date: Jul. 8, 2004

(54) Method and device for the remote transmission of sensitive data

(76) Inventor: Juergen Plessmann, Fuerth (DE)

Correspondence Address: SCHIFF HARDIN, LLP, PATENT DEPARTMENT, 6600 SEARS TOWER, CHICAGO, IL, 60606-6473, US

(21) Appl. No.: 10/716,003

(22) Filed: Nov. 18, 2003

(30) Foreign Application Priority Data
Nov. 18, 2002 (DE) 10253676.7

(51) Int. Cl. G06F 15/16

(52) U.S. Cl. 709/200

(57) ABSTRACT

The invention concerns a method for the remote transmission and/or observation of sensitive data of an application computer. According to the invention, the remote transmission and/or observation of the sensitive data ensues upon request. Before the remote transmission and/or observation, constituent data parts requiring secrecy of the requested data, for example, data to identify people, are identified and eliminated. The invention moreover concerns a data protection module for the remote transmission and/or observation of sensitive data of an application computer. According to the invention, the remote transmission and/or observation of the sensitive data can be requested. Upon such a request, the sensitive data can be transmitted form the application computer to the data protection module. Constituent data parts requiring secrecy of the requested data, for example name, age and/or address, can be identified and excluded from the remote transmission and/or observation by the data protection module.

### BACKGROUND OF THE INVENTION

The invention concerns a method and a device for the remote transmission of sensitive data. “Sensitive data” means data that in part require secrecy, thus comprising constituent data parts requiring secrecy.

Modern communication technology enables the transmission of the widely varied data between different sites. To process and transmit the data, computers are used that can be connected with one another via local networks, telephone connections, wireless interfaces, or the Internet. The transmission of data over these connections is, for the most part, interceptable, and a plurality of mechanisms exist for their cryptographic protection. These mechanisms either aim to protect the entire communication path or they serve to encrypt complete files or, respectively, databanks.

An effective protection of data is particularly in demand in the field of medicine, in research and development as well as in the finance industry. In these fields, the communication of data is extremely important, as is the use of computers to process data. The computer systems and communication paths are cryptographically protected to the greatest possible extent against being overheard.

Due to the plurality of computer systems in use (that are, in part, highly complex) intensive maintenance measures are required. Unanticipated maintenance may also be required at irregular time intervals, for example, when errors occur. Depending on which parts of the computer system are affected by errors, it can be necessary in the maintenance to also reveal applications that process sensitive data, for example, to a maintenance technician. This may be unacceptable for a maintenance measure at a site because the maintenance technician may not belong to a circle of people authorized for knowledge of the sensitive data. Even more critical is the situation for remote maintenance measures when, for example, functions of the application programs or screen contents must be transmitted over fundamentally unprotected communication paths.

For example, it can be necessary, given the medical examination of a patient with a computer-controlled diagnosis device, to call in a maintenance professional in order to enable an optimization or error correction in the system that ensue during the computer-controlled diagnostic application. Similar problem conditions can arise, for example, when errors ensue in a computer-controlled finance application that must be demonstrated in a running operation mode to the maintenance professional. Given the inspection in running systems, it is unavoidable that constituent data parts requiring secrecy are also visible.

In addition to maintenance, an inspection in such computer systems can also be required for training purposes in order be able to demonstrate the operation of complex applications. This is frequently only possible when data is available with which the application can be used, this comprising the actual secure data. However, training people that are not authorized to inspect such data is then forbidden.

Furthermore, the inspection can also be necessary directly in medical surroundings, in the framework of “expert systems”, in which other clinical experts are consulted for evaluation of clinical data. It is necessary that data such as diagnostic exposures or the pathogenesis of a patient are made accessible to the consulted experts. However, personal data of the patient file are, in such situations, inevitably transmitted as well, and such data are also possibly revealed to unauthorized viewers.

A particularly fast and efficient data exchange ensues mostly via a remote data transmission. This is true for training measures and expert systems, as well as for remote maintenance measures that avoid wait times associated with an appearance of maintenance personnel on site. Moreover, expert systems can also be made usable for maintenance specialists. For remote maintenance, it is possible for a maintenance specialist operating remotely to view the data on an application computer. This includes the inspection of fixed disc data as well as of running process data in the working storage; in addition screen contents can also be transmitted in order to make current notifications visible and to be able to mutually reproduce screen events. The remote maintenance of special applications thereby requires compatible hardware and software that are present both on the application computer and on the remote maintenance computer.

German patent document DE 196 51 270 C2 deals with the possibilities of remote maintenance, particularly of medical-diagnostic devices that operate with the aid of a computer (for example, CT tomographs, MR scanners or image archive workstations). This reference discloses a solution to flexibly design remote maintenance in standard common programming languages (e.g., HTML). However, this reference does not disclose a mechanism to prevent the viewing of sensitive data by the maintenance technician.

### SUMMARY OF THE INVENTION

The object of the invention is to permit inspection in computer-aided applications that allows the inspecting individual as broad a view as possible into the data and processes of the application computer, however without simultaneously allowing secret data to be viewed.

This object is achieved by a method for accessing sensitive data comprising at least one of remotely transmitting and observing the sensitive data of an application computer, comprising: requesting access to the sensitive data that is a least one of remotely transmitting and observing the sensitive data; identifying constituent data parts requiring secrecy of the sensitive data; and excluding the constituent data parts from the access.

This object is also achieved by a data protection module for remote access to sensitive data of an application computer, comprising: an application request input by which the application computer can transmit the sensitive data to the data protection module; an identification mechanism configured to identify constituent data parts of the sensitive data; an exclusion mechanism configured to exclude the identified constituent data parts; and an output configured to output the sensitive data without the constituent data parts.

The invention primarily deals with the availability of all data in a computer-aided application, namely for viewing or remote transmission, while at the same time simultaneously excluding from the transmission or viewing all constituent data parts requiring secrecy. A viewer at a computer to which the data are transmitted can view and track all data and processes of the computer-aided application. However, at the same time unauthorized access is not permitted to constituent data parts requiring secrecy. “All data” means information of any kind available on the computer (for example, fixed disc contents, working storage contents or screen display contents). “Constituent data parts” means data such as name, age, address of persons, ID's, UID's, passwords, social security numbers, bank account data, financial information or survey data.

In an advantageous embodiment of the invention, the constituent data parts requiring secrecy are either erased, anonyminized or pseudonyminized, depending on the requirements. “Anonyminization” means any action making personal constituent data parts unrecognizable, such that particulars about personal or clinical/factual matters cannot be associated with the appertaining person, or can only be associated with extremely large expenditure of time, costs and labor.

“Pseudonymizing” means making of the name and other identifying features unrecognizable via a code in order to not allow or to substantially hamper the identification of the appertaining person. This has the advantage that, depending on the application, corresponding data fields are either empty or are filled with anonymous or pseudonymous display elements that give the viewer an indication as to what type of information is placed at the respective location, and at which location information is namely present but not visible.

In a further advantageous embodiment of the invention, constituent data parts requiring secrecy are also eliminated from the screen contents or the contents of other display elements. The advantage is that a viewer situated remotely to analyze a system operating on site can also interactively view and track events on the screen without obtaining access to data requiring secrecy.

In a further advantageous embodiment of the invention, the remote transmission of data ensues at the request of a remotely arranged computer; this may involve a workstation of a service provider that wishes to undertake a remote maintenance of the computer operating on site. In spite of the presence of data requiring secrecy, this embodiment can ensure that the maintenance personnel can call upon highly specialized maintenance services without consideration of the respective authorization status. This permits fast and efficient remote maintenance of application computers with data requiring secrecy, and also when changing maintenance services. The use of changing, different maintenance services occurs frequently in practice.

In a further advantageous embodiment of the invention, the elimination of constituent data parts requiring secrecy is effected via a data protection module that can be integrated into an application computer as a card or that can be connected as an independent device to an application computer. This is advantageous because, if required, almost every computer workstation can be modularly equipped with the data protection module. A subsequent equipping or adapting the functionality of the application computer can also ensue given changing application areas.

Further advantageous embodiments of the inventive method encompass excluding the constituent data parts comprises at least one of erasing, anonymizing, and pseudonyminizing the data. An embodiment includes storing information related to constituent data parts requiring secrecy in a reference databank; wherein identifying constituent data parts comprises comparing the constituent data parts with the stored information related to the constituent data parts in the reference databank. The reference databank may be a name databank, and address databank, or a people databank. Identifying constituent data parts may be performed by utilizing a search mask. The search mask may be related to at least one of a date-specification format and an address-specification format. Identifying constituent data parts may be performed by utilizing a data position within the sensitive data. This data position may be related to at least one of a name data field and an address data field. The sensitive data may comprise at least one of a screen content and a video frame. The method may also have a remotely arranged computer request data for remote maintenance of an application computer; and transmit the data upon the request of a remotely arranged computer.

Further advantageous embodiments of the inventive data protection module includes having the constituent data parts comprises at least one of name, age, and address. The data protection module may be configured as at least one of a card that is installable in the application computer, a device that can be connected to the application computer, and an integral component of the application computer. The module may further comprise at least one of an eraser, an anonymizer, and a pseudonymizer for the constituent data parts. It may also further comprise a reference databank input via which the data protection module can access a reference databank; and a comparison mechanism configured to identify the constituent data parts based on content of the reference databank. The reference databank may at least one of a name data bank, an address databank, and a people databank. The data protection module may further comprising an access mechanism to a search mask storage; and a search mask comparison mechanism configured to identify the constituent data parts based on content of the search mask storage. The search mask storage may comprise at least one of a data search mask and an address-specification search mask. The module may further comprise a position detection mechanism configured to identify the constituent data parts based on a position of data within the sensitive data. The data position may be related to at least one of a name data field and an address data field. The module may further comprise an image data processor configured to process screen content or a video frame, the image data processor may be further configured to identify the constituent data parts based on sensible content of the screen content or video frame. The module may further comprise a data connection to a remotely arranged computer via which a request of the remotely arranged computer for transmission of the sensitive data can be received; a data connection via which the request for the transmission of sensitive data can be transmitted to an application computer, the application computer having a data connection via which the sensitive data can be received by the application computer; and a data connection via which the sensitive data can be transmitted to the remotely arranged computer. Finally, the module may further comprise a data connection to a storage that comprises identification data for identification of a remotely arranged maintenance computer, wherein the remotely arranged maintenance computer may be identifiable by the data protection module using the identification data, and that data can only be transmitted to a remotely arranged computer depending on a result of the identification.

### DESCRIPTION OF THE DRAWINGS

Exemplary embodiments of the invention are subsequently explained using figures.

FIG. 1 is a schematic block diagram of a computer system with data protection modules according to an embodiment of the invention; and

FIG. 2 is a flowchart illustrating a method to implement an embodiment of the invention.

### DETAILED DESCRIPTION OF THE PREFERRED EMBODIMENTS

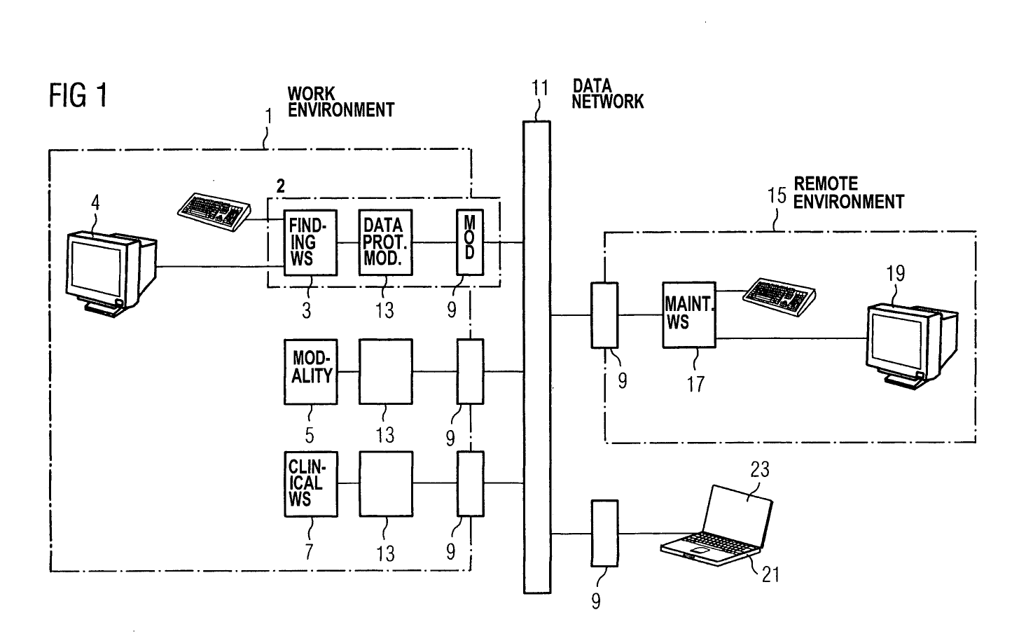

FIG. 1 shows a computer system with data protection modules 13 according to an embodiment of the invention. The computer system is present in a work environment 1 that uses sensitive data, for example, a clinical environment, an environment in finance or in a survey institute. In this work environment 1, a workstation 3 is installed as a finding workstation that possesses a screen 4 and on which sensitive data are processed, stored, archived or otherwise made available.

Insofar as the sensitive data are made available to other workstations within the work environment 1, this ensues via communication paths that are not explicitly shown in FIG. 1 and that satisfy the special data protection obligations of the work environment. However, the workstation 3 also possesses a connection to communication paths that allow the exchange of data via communication paths outside of the work environment 1. The connection to these communication paths may ensue via a modem 9, where the term “modem” is understood to be a telephone modem as well as a radio modem or any other type of network connection.

Since the workstation 3 has access to sensitive data, unauthorized access to the workstation 3 via the modem 9 must be monitored or prevented via the data protection module 13. Data access via this route only ensues upon a request for remote transmission or viewing that the data protection module 13 allows to act. Upon this request, no direct access to the sensitive data is allowed, rather the data protection module 13 is activated as an intermediate entity. The activation of the data protection module 13 can ensue dependent upon factors such as the identity of the requester, or dependent upon factors such as the respective data access, i.e., dependent on the internal or external position of the requester, or dependent on the input of a user that can directly activate the data protection module 13.

The data protection module 13 and the modem 9 can be integrated into the workstation as plug-in cards or plug-in modules and form a common hardware assembly, which is indicated by the dashed framing 2. However, the components can be connected to the workstation as independent devices without impairment of the function. Moreover, data protection module 13 and modem 9 can, for their part, be integrated as a common component, which is not shown in FIG. 1.

Additionally, the data protection module 13 can also be a software module integrated into the workstation 3, into a separate server or into the modem 9. Furthermore, the sequence of data protection module 13 and modem 9 can also be exchanged, such that the modem 9 is directly connected to the workstation 3 and has a connection via the data protection module 13 to the communication paths outside of the work environment.

In the work environment 1, further computer-aided workstations can be installed that likewise operate with sensitive data, for example, a modality 5 that serves to generate medical diagnostic image data, or a clinical workstation 7 that enables the processing of found data and medications by way of electronic patient files. Furthermore and (depending on work environment) separately, various computer-aided applications can be envisioned that all operate with sensitive data and can be connected with one another within the work environment 1 via internal data networks (not shown in FIG. 1). For each of these workstations, a data connection to communication paths/data networks 11 outside of the work environment 1, protected by a data protection module 13, can be established via a modem 9.

Insofar as the data connections to external communication paths 11 serve to exchange sensitive data, including the constituent data parts requiring secrecy, known cryptographic data protection mechanisms may be used that are not the subject matter of the invention. However, there is a plurality of data connections that are produced namely to exchange sensitive data, although not constituent data parts requiring secrecy. An application of such data connections can be an inspection in data in the framework of an expert system, in which clinical experts outside of the work environment 1 are consulted with regard to the constituent data parts not requiring secrecy, however for this the constituent data parts requiring secrecy are not necessary. Data connections are also imaginable for other purposes, for example, to exchange common information from the applications, or to establish personally usable communication connections for the sending of e-mail or transmission of files that have no direct relationship to the applications, however that open up access possibilities to the computer within the work environment 1.

Data connections outside of the work environment 1 can serve for the remote maintenance of the computer-aided applications, in that, for example, the version number of installed software may be requested from the remote environment 15, software may be provided from the remote environment 15, and error messages can be viewed from outside, as can computer behavior or performance requiring optimization. Such remote maintenance measures are generally common since the inspection via electronic data connections can ensue quickly and, as the case may be, also enables the consultation of further maintenance specialists in a remote maintenance service center. This type of maintenance concerns installed hardware or software and their functionality, for which, if necessary, application programs must be started. However, no inspection by maintenance specialists of data requiring secrecy should thereby ensue in order to permit operation independent of their authorization status.

A remote maintenance of the application computer of the work environment 1 can ensue from a remote environment 15 such as a remote maintenance center that, for example, is operated by the producer of the software or by a special maintenance business. The connection to such a maintenance center 15 ensues via the public communication paths 11, with which the remote maintenance center 15 is likewise connected via a modem 9. The connection is established by a maintenance workstation 17 with monitor 19, from which a maintenance specialist has access to the computer to be serviced, its installed software, and all data not protected by the data protection module 13. In the framework of this access, data can be viewed, applications can be started on the application computer 3, 5, 7, the screen contents of the application display 4 can be viewed, or maintenance programs can be started on the application computer 3, 5, 7 or on the maintenance workstation 17.

However, the maintenance access is not only possible from a service center 15, but rather also from other service computers, for example from a notebook 21 that likewise can contact the application computer 3, 5, 7 via a modem 9. The same functionalities as from the service center 15 are thereby available, which, in particular, comprise the viewing of the screen contents of the application display 4 on the notebook display 23. However, the maintenance via a notebook 21 or a similar portable device also allows a maintenance use on site, that may be necessary given the consideration of hardware questions for maintenance purposes.

For this purpose, the modem 9 allows a data connection, not only via public communication paths 11, but rather also in direct connection to a corresponding modem or connection on the application computer 3, 5, 7. However, such a maintenance access on site in the work environment 1 is also protected via a data protection module 13, since the maintenance specialist on site also receives no insight into data requiring secrecy.

The use of a maintenance notebook 21 via a connection protected by a data protection module 13 enables it to service a connection computer without having to see its application screen 4 on which the data requiring secrecy can be displayed. However, instead of this, the possibility also exists to be able to likewise protect, via the data protection module 13, the contents shown on the application screen 4, in the event servicing takes place. For this purpose, the data protection module 13 must be integrated into the application computer 3 or into the connection between the application computer 3 and application display 4. The data protection for screen contents can then be activated by way of pushing a button, in case that the machine is serviced.

The data protection module 13 prevents the inspection of constituent data parts requiring secrecy. However, application programs that are based on data requiring secrecy should remain executable, and other data contents of the computer should be freely accessible for analysis. This is particularly necessary for optimization or maintenance of application programs insofar as shortcomings or errors are analyzed that are only viewable when operating application programs using sensitive data. For this reason, in principle, all data and screen contents are transmitted via the data protection module 13. However, before the transmission, the data protection module 13 identifies constituent data parts requiring secrecy of the data to be transmitted.

Such constituent data parts can, in particular, be personal or demographic information, for example, the name of patients or customers, ID's, UID's, passcode, social security number, birthdate, address, bank connections/data, information about financial status, or results of critical surveys or statistical evaluations.

Of particular importance is the secrecy of personal information in the medical environment, where all information about personality, pathogenesis and diagnosis of patients exists in the form of patient files. Here, particularly sensitive data is operated on with very complex application computers. At the same time, the optimal state of the application computer in the medical environment is an imperative condition that makes a particularly efficient and intensive maintenance of the systems absolutely necessary.

Given the transmission of patient records or files of predetermined formats, the data protection module 13 identifies data fields within the files or records that comprise constituent data parts requiring secrecy. For this, the data protection module 13 has access to an integrated or connected storage that comprises an allocation of data formats and data fields requiring secrecy comprised therein that enables, for example, the recognition of such data fields by the data field identifications. The storage can, in particular, be a non-erasable storage integrated into the data protection module 13, for example Flash, an EPROM or an EEPROM. However, it can also be a fixed disk or other similar storage media. Insofar as files or electronic records are transmitted, this ensues via a communication protocol that is supported by the data protection module 13, for example TCPIP or FTP. Moreover, the data protection module 13 supports the file format of the data to be transmitted. A transmission of data in unsupported file formats or communication protocols is not possible.

The data protection module 13 has further access to a reference databank that comprises data requiring secrecy. It is thereby possible to compare the transmitted data with the content of the reference databank in order to recognize constituent data parts requiring secrecy. The reference databank can comprise data that, upon creating files and records within the work environment 1, comprise a notation that indicates the necessity of secrecy. This notation effects that the corresponding data are filled in the reference databank. In a databank system, the corresponding data could be stored in the reference databank and are respectively retrieved by the applications from this databank. The reference databank can be, for example, a people databank, for whose protection separate data protection measures can be applied. The data protection module 13 completely prevents the transmission of data that occur in the reference databank.

The reference databank can also comprise a list of possible information requiring secrecy that is created independent of the work environment 1. For example, to protect personal data, a reference databank can be installed that comprises an index of all known first names and last names, and is independent of whether the respective name is used in the work environment 1 or not. This assures that the data protection module 13 can prevent the transmission of any names via comparison with the reference databank. In a comparable manner, all medical-diagnostic results, critical items of finance, or critical demographic items can be filed in a reference databank.

The data protection module 13 has further access to a storage in which search masks for constituent data parts requiring secrecy are filed. These could be, for example, date search masks for prevalent data formats such as ##.##.####, ##/##/## or ##.mmm.####, Search masks for address specifications can also be filed that, for example, recognize typical combinations of street name and street number or postal code and location as well as country specification. Additionally, search masks for sales data using the specification of currencies can be recognized, or search masks to any figure or any letter can be used.

Furthermore, the data protection module 13 can also support the transmission of data that represent screen contents or video frames. These screen representations, currently displayed or stored in graphic storage, can likewise be transmitted for purposes of remote maintenance, training, or inspection, in order, for example, to make interactive processes or screen messages remotely viewable. Since they can comprise constituent data parts requiring secrecy of the application computer 3, 5, 7, their transmission is likewise protected from unauthorized inspection.

For this, the data protection module provides routines that also enable the recognition of these constituent data parts in screen contents. However, the screen contents are not present in typical data formats, such as ASCII, but rather must be specially analyzed via data recognition programs. For this purpose, the screen data are reconverted (in a manner analogous to OCR programs) as much as possible into ASCII data, insofar as they are not transmitted in ASCII-related data formats. The ASCII-related screen contents, or screen contents transferred back into ASCII, are searched using search masks or reference databanks for constituent data parts requiring secrecy, just as the files and electronic records to be transmitted are. The data protection module 13 thus treats screen contents and video frames in a manner comparable to files and electronic records. Constituent data parts requiring secrecy that are recognized by the data protection module 13 are either erased from the data to be transmitted, anonyminized, or psuedonyminized.

Additionally, screen contents can be checked and protected in a substantially simpler manner before their display on the screen 19, 23. For this, the data protection module 13 already identifies constituent data parts requiring secrecy before their visualization of the data to be shown and eliminates them. The organization of screen contents then ensues first in connection with the processing via the data protection module 13. A more reliable protection of the sensitive data is thereby also assured given transmission of screen contents, without requiring particular routines, for example, to analyze pixel-based video frames.

Given transmission of files or records with set predetermined data fields, the erasure of constituent data parts leads to the receiver receiving files with partially empty data fields. However, the context of the information is not changed by the set predetermined formats of the files or records, such that the transmitted information remains easy to read for the receiver. However, in specific situations, it can be necessary that the receiver receives an indication that a constituent data part was excluded from the transmission, and at what location. For this reason, the data protection module 13 provides routines that do not erase from the transmission the data to be excluded, but rather anonyminize or pseudonyminize it.

For anonymization, personal constituent data parts of any kind about personal or factual relationships should be made unrecognizable or no longer associable. For this, for example, in place of the erased data, a censor mask can be cross-faded, for example, a rhombus in place of each erased figure or an x in place of each letter. Additionally, a garbling in the form of blackenings or censor masks independent of content is possible.

For pseudonyminization, names and other identification features are replaced by a code in order to make the identification of the appertaining person impossible. In place of the personal constituent data parts, respectively a pseudonym is thus transmitted, for example “Max Mustermann”, “Prename Name” or “ID” or “UID”.

Both anonymization and particularly pseudonyminization on the one hand signal to the receiver of the transmitted data which type of data was excluded from the transmission, thus whether it was names, addresses, birthdates or the like; on the other hand, the receiver receives an item of information about from which position of the transmitted data constituent data parts were excluded. This information can, in particular, be important in the maintenance of application programs, their functionality can be dependent on whether specific data fields are filled or whether specific information is available.

For remote maintenance purposes, the data protection module 13 exhibits, in particular, the possibility to receive and to process data requests. For this purpose, it can receive the request of a remote maintenance computer 17 via a data connection. With this request, identification data of the remote maintenance computer 17 can be transmitted that the data protection module 13 checks via comparison with identification data that it receives from an identification storage. The identification storage may be integrated into the data protection module 13 as non-erasable storage, or may be accessible as an external storage, for example, in the application computer. If the remote maintenance computer 17 can be identified, the data protection module 13 forwards the data request to the application computers 3, 5, 7 via a data connection provided for this. It then receives the data to be transmitted via a sequence control provided for this and forwards them to the remote maintenance computer 17, where constituent data parts to be kept secret are excluded from the transmission.

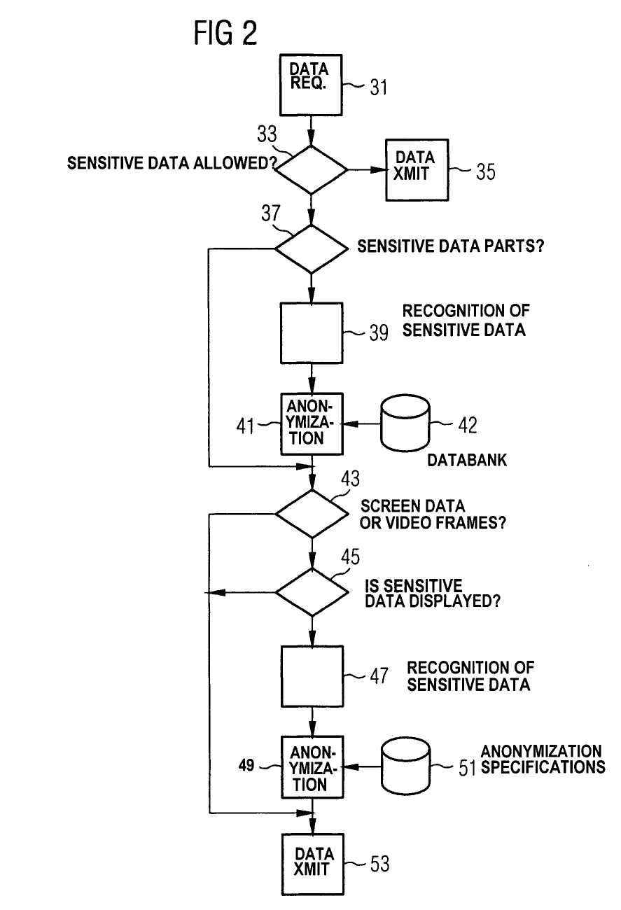

FIG. 2 shows a method for the remote transmission of sensitive data according to an embodiment of the invention. The request for data is made 31 via a remote or separately arranged computer 17, 21, or a user of a specific classification, meaning a specific authorization status on an application computer 3, 5, 7 for remote transmission or viewing of data. A check is made 33 as to whether the entire transmission of all data to the requesting computer is allowed, otherwise a check is made 37 whether the data to be transmitted comprise sensitive constituent data parts. The check for sensitive constituent data parts may ensue either using a corresponding identification of the files or records to be transmitted or by utilizing search masks or via comparison with the content of reference databanks.

All constituent data parts requiring secrecy of the data to be transmitted are recognized in this manner 39, and are either erased, anonyminized or psuedonyminized 41. Which of the three possibilities is implemented, and which formats or pseudonyms are used, is determined using the anonyminization specifications comprised in a databank 42. A decision is made as to which of the three variants is selected, dependent on the type of the data to be transmitted, for example, whether they are files or communication data such as e-mail or chat data, and dependent on the content of the data, for example, whether they are patient records or image data.

A check is made as to whether the data to be transmitted comprise screen data or video frames 43. If necessary, an examination is made 45, using suitable routines, whether these screen contents or video frames comprise data requiring secrecy in, e.g., an ASCII-related format or in a format restored to ASCII. In the case that they are, these data requiring secrecy are recognized 47 and excluded from the transmission 49. For this purpose, an anonyminization databank 51 is accessed that comprises specifications about whether and in what manner the constituent data parts requiring secrecy should be erased, anonyminized or pseudonyminized. The transmission of the requested data ensues 53, by which all constituent data parts requiring secrecy were excluded from the transmission via the preceding method.

The method according to the invention is suitable in a particular manner for the remote maintenance of application computers 3, 5, 7 in work environments 1 with sensitive data, since the method 31 can be initiated via the remote request of a remote maintenance computer 17. For this purpose, an identification of the remote maintenance computer can be placed at the beginning of the method, via which it can be ensured that only authorized remote maintenance computers 17, 21 receive access to the sensitive data and application computers 3, 5, 7.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illutrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention. REFERENCE LIST

1 work environment

2 data processing device

3 finding workstation

4 finding screen

5 modality

6 clinical workstation

7 modem

8 data network

9 data protection module

10 remote maintenance environment

17 maintenance workstation

19 maintenance screen

21 maintenance notebook

23 notebook screen

31 data request

33 is the transmission of sensitive data allowed?

35 data transmission

37 sensitive data parts?

39 recognition of sensitive data

41 anonyminization

42 data bank

43 screen data or video frames?

45 is sensitive data displayed?

47 recognition of sensitive data

49 anonyminization

51 anonyminization specifications

53 data transmission

What is claimed is:

1. A method for accessing sensitive data comprising at least one of remotely transmitting and observing the sensitive data of an application computer, comprising:
requesting access to the sensitive data that is a least one of remotely transmitting and observing the sensitive data;
identifying constituent data parts requiring secrecy of the sensitive data; and
excluding the constituent data parts from the access.

2. The method according to claim 1, wherein excluding the constituent data parts comprises at least one of erasing, anonymizing, and pseudonyminizing the data.

3. The method according to claim 1, further comprising:
storing information related to constituent data parts requiring secrecy in a reference databank;
wherein identifying constituent data parts comprises comparing the constituent data parts with the stored information related to the constituent data parts in the reference databank.

4. The method according to claim 3, wherein the reference databank is selected from the group consisting of a name databank, an address databank, and a people databank.

5. The method according to claim 1, wherein identifying constituent data parts is performed by utilizing a search mask.

6. The method according to claim 5, wherein the search mask is related to at least one of a date-specification format and an address-specification format.

7. The method according to claim 1, wherein identifying constituent data parts is performed by utilizing a data position within the sensitive data.

8. The method according to claim 7, wherein the data position is related to at least one of a name data field and an address data field.

9. The method according to claim 1, wherein the sensitive data comprises at least one of a screen content and a video frame.

10. The method according to claim 1, further comprising:
requesting, by a remotely arranged computer, data for remote maintenance of an application computer; and
transmitting the data upon the request of a remotely arranged computer.

11. A data protection module for remote access to sensitive data of an application computer, comprising:
an application request input by which the application computer can transmit the sensitive data to the data protection module;
an identification mechanism configured to identify constituent data parts of the sensitive data;
an exclusion mechanism configured to exclude the identified constituent data parts; and
an output configured to output the sensitive data without the constituent data parts.

12. The data protection module according to claim 11, wherein the constituent data parts comprises at least one of name, age, and address.

13. The data protection module according to claim 11, wherein the data protection module is configured as at least one of a card that is installable in the application computer, a device that can be connected to the application computer, and an integral component of the application computer.

14. The data protection module according to claim 11, further comprising at least one of an eraser, an anonymizer, and a pseudonymizer for the constituent data parts.

15. The data protection module according to claim 11, further comprising:
a reference databank input via which the data protection module can access a reference databank; and
a comparison mechanism configured to identify the constituent data parts based on content of the reference databank.

16. The data protection module according to claim 15, wherein the reference databank is at least one of a name data bank, an address databank, and a people databank.

17. The data protection module according to claim 11, further comprising:
an access mechanism to a search mask storage; and
a search mask comparison mechanism configured to identify the constituent data parts based on content of the search mask storage.

18. The data protection module according to claim 17, wherein the search mask storage comprises at least one of a data search mask and an address-specification search mask.

19. The data protection module according to claim 11, further comprising:
a position detection mechanism configured to identify the constituent data parts based on a position of data within the sensitive data.

20. The data protection module according to claim 19, wherein the data position is related to at least one of a name data field and an address data field.

21. The data protection module according to claim 11, further comprising:
an image data processor configured to process screen content or a video frame, the image data processor being further configured to identify the constituent data parts based on sensible content of the screen content or video frame.

22. The data protection module according to claim 11, further comprising:
a data connection to a remotely arranged computer via which a request of the remotely arranged computer for transmission of the sensitive data can be received;
a data connection via which the request for the transmission of sensitive data can be transmitted to an application computer, the application computer having a data connection via which the sensitive data can be received by the application computer; and
a data connection via which the sensitive data can be transmitted to the remotely arranged computer.

23. The data protection module according to claim 22, further comprising:
a data connection to a storage that comprises identification data for identification of a remotely arranged maintenance computer, wherein the remotely arranged maintenance computer is identifiable by the data protection module using the identification data, and that data can only be transmitted to a remotely arranged computer depending on a result of the identification.
